(19) United States
(12) Patent Application Publication
(10) Pub. No.: US 2017/0153697 A1
(43) Pub. Date: Jun. 1, 2017

(54) ELECTRONIC DEVICE AND METHOD FOR CONTROLLING THE SAME

(71) Applicant: LG ELECTRONICS INC., Seoul (KR)

(72) Inventors: Jihyun KIM, Seoul (KR); Sungjae CHUNG, Seoul (KR); Youngkyung JUNG, Seoul (KR); Sungyup KIM, Seoul (KR)

(73) Assignee: LG ELECTRONICS INC., Seoul (KR)

(21) Appl. No.: 15/323,387

(22) PCT Filed: Jul. 1, 2014
(86) PCT No.: PCT/KR2014/005862

§ 371 Date: Dec. 30, 2016

(51) Int. Cl. G06F 3/01; G09G 5/12; G09G 5/00; G06T 11/60

(52) U.S. Cl. CPC G06F 3/011; G06T 11/60; G09G 5/12; G09G 5/003; G06F 2203/011; G09G 2354/00; G09G 2370/16

(57) ABSTRACT

An electronic device and a method of controlling the same are disclosed. According to the present invention, an electronic device comprises a sensor; a memory storing content; a controller configured to: acquire a plurality of feeling information on the content thorough the sensor which is operated when the content is reproduced; evaluate a user's good feeling for the content based on the acquired plurality of feeling information; calculate the user's good feeling using weighted values assigned to the plurality of feeling information; and apply a larger weighted value to latest feeling information among the plurality of feeling information. According to the present invention, among a plurality of feeling information obtained upon reproduction of content, latest feeling information may be assigned with a larger weighted value to evaluate a good feeling on specific content.

### TECHNICAL FIELD

The present invention relates to an electronic device that may evaluate a good feeling on specific content by applying a larger weighted value to latest feeling information among a plurality of feeling information obtained upon reproduction of content and a method of controlling the same.

### BACKGROUND ART

Terminals may be generally classified as mobile/portable terminals or stationary terminals according to their mobility. Electronic devices may also be classified as handheld terminals or vehicle mounted terminals according to whether or not a user can directly carry the terminal.

Various types of electronic devices may play various types of content according to users' taste, and more and more content are played by an electronic device. Accordingly, a research as to the efficient way to play certain content among a number of content is underway.

### DISCLOSURE

### Technical Problem

An object of the present invention is to solve the foregoing and other problems. Another object of the present invention is to provide an electronic device that may evaluate a good feeling on specific content by applying a larger weighted value to latest feeling information among a plurality of feeling information obtained upon reproduction of content and a method of controlling the same.

### Technical Solution

To achieve the foregoing or other objects, according to an aspect of the present invention, there is provided an electronic device comprising: a sensor; a memory storing content; a controller configured to: acquire a plurality of feeling information on the content thorough the sensor which is operated when the content is reproduced; evaluate a user's good feeling for the content based on the acquired plurality of feeling information; calculate the user's good feeling using weighted values assigned to the plurality of feeling information; and apply a larger weighted value to latest feeling information among the plurality of feeling information.

The sensor may include a first sensor and a second sensor configured to obtain the user's good feeling, and the controller is configured to evaluate the good feeling by a combination of first good feeling obtained through the first sensor and second good feeling obtained through the second sensor.

The good feeling may include first good feeling obtained at a first time of reproducing the first content and second good feeling obtained at a second time of reproducing the content, the controller is configured to evaluate the good feeling by applying a first weighted value to the first time and a second weighted value to the second time when the first time is earlier than the second time, and the first weighted value is smaller than the second weighted value.

The controller may be configured to change a way to reproduce the content based on the good feeling.

The way to reproduce the content may include at least one of a position, frequency, or time of expressing the content.

The controller may be configured to remove the content from the memory when the good feeling evaluated for the content is a predetermined degree or lower or when the good feeling is a predetermined degree or lower and lasts for a predetermined time.

The content may be image content, and the controller may be configured to change an order of the image content in an image gallery depending on a degree of the good feeling for the image content.

The electronic device may further comprise a wireless communication unit, and the controller is configured to transmit the evaluated good feeling to a second electronic device through the wireless communication unit and to reproduce, instead of the content, second content obtained from the second device.

According to another aspect of the present invention, there is provided a method of controlling an electronic device, the method comprising: obtaining content; acquiring a plurality of feeling information on the content thorough the sensor which is operated when the content is reproduced; evaluating a user's good feeling for the content based on the acquired plurality of feeling information; calculating the user's good feeling using weighted values assigned to the plurality of feeling information; and applying a larger weighted value to latest feeling information among the plurality of feeling information.

Acquiring the good feeling may include acquiring the good feeling through a plurality of sensors including a first sensor and a second sensor that may obtain the user's good feeling, and evaluating the user's good feeling may include evaluating the good feeling by a combination of first good feeling obtained through the first sensor and second good feeling obtained through the second sensor.

The good feeling may include first good feeling obtained at a first time of reproducing the first content and second good feeling obtained at a second time of reproducing the content, evaluating the good feeling includes evaluating the good feeling by applying a first weighted value to the first time and a second weighted value to the second time when the first time is earlier than the second time, and the first weighted value may be smaller than the second weighted value.

The method may further comprise changing a way to reproduce the content based on the good feeling.

The way to reproduce the content may include at least one of a position, frequency, or time of expressing the content.

Changing the way may include removing the content from the memory when the good feeling evaluated for the content is a predetermined degree or lower or when the good feeling is a predetermined degree or lower and lasts for a predetermined time.

The method may further comprise transmitting the evaluated good feeling to a second electronic device; and reproducing, instead of the content, second content obtained from the second device.

### Effects

According to the present invention, an electronic device and a method of controlling the same provide the following effects.

According to at least one of the embodiments of the present invention, a good feeling on specific content may be evaluated by applying a larger weighted value to latest feeling information among a plurality of feeling information obtained upon reproduction of content and a method of controlling the same.

Additional range of applicability of the present invention will be apparent from the detailed description given below. However, it will be appreciated by those skilled in the art that various changes and modifications may be made thereto without departing from the scope and spirit of the present invention, and it should be also appreciated that the above-described embodiments are given merely as an example.

### Advantageous Effects

According to the present invention, an electronic device and a method of controlling the same provide the following effects.

According to at least one of the embodiments of the present invention, a good feeling on specific content may be evaluated by applying a larger weighted value to latest feeling information among a plurality of feeling information obtained upon reproduction of content and a method of controlling the same.

Additional range of applicability of the present invention will be apparent from the detailed description given below. However, it will be appreciated by those skilled in the art that various changes and modifications may be made thereto without departing from the scope and spirit of the present invention, and it should be also appreciated that the above-described embodiments are given merely as an example.

### DESCRIPTION OF DRAWINGS

FIG. 1A is a block diagram of an electronic device in accordance with the present disclosure.

FIGS. 1B and 1C are conceptual views of one example of the electronic device, viewed from different directions;

FIG. 2 is a flowchart illustrating an operation of an electronic device as shown in FIG. 1;

FIG. 3 is a view illustrating a method of obtaining content by an electronic device as shown in FIG. 1, according to an embodiment of the present invention;

FIGS. 4 to 6 are views each illustrating an electronic device as shown in FIG. 1, according to an embodiment of the present invention;

FIG. 7 is a view illustrating information sensed through an electronic device as shown in FIG. 1, according to an embodiment of the present invention;

FIGS. 8 to 11 are views illustrating feeling information based on information obtained through an electronic device as shown in FIG. 1; and

FIGS. 12 to 16 are views illustrating a method of using feeling information obtained through an electronic device as shown in FIG. 1.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Electronic devices presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of electronic devices. However, such teachings apply equally to other types of terminals, such as those types noted above. In addition, these teachings may also be applied to stationary terminals such as digital TV, desktop computers, and the like.

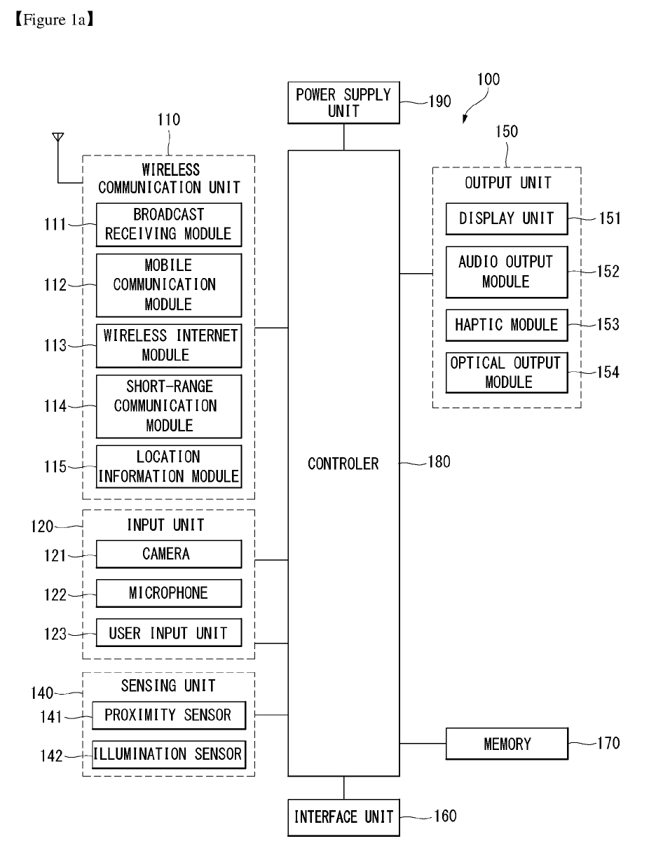

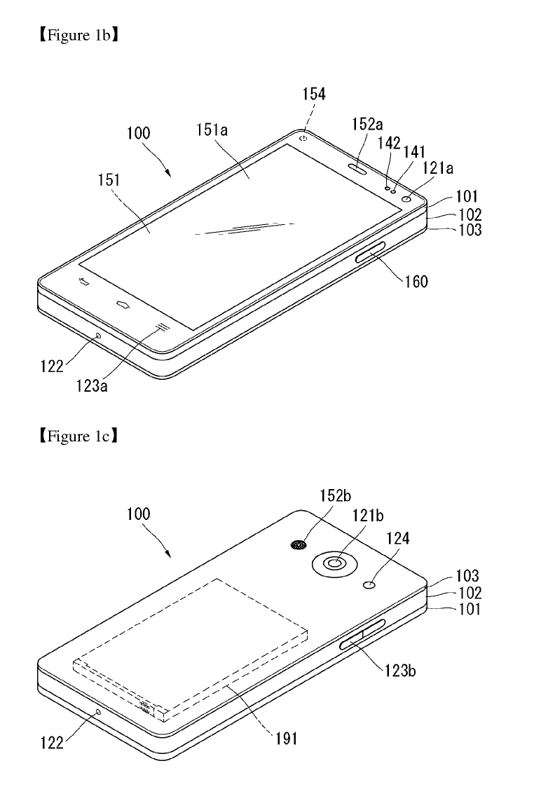

Reference is now made to FIGS. 1A-1C, where FIG. 1A is a block diagram of an electronic device in accordance with the present disclosure, and FIGS. 1B and 1C are conceptual views of one example of the electronic device, viewed from different directions.

The electronic device 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the electronic device 100 is shown having wireless communication unit 110 configured with several commonly implemented components. For instance, the wireless communication unit 110 typically includes one or more components which permit wireless communication between the electronic device 100 and a wireless communication system or network within which the electronic device is located.

The wireless communication unit 110 typically includes one or more modules which permit communications such as wireless communications between the electronic device 100 and a wireless communication system, communications between the electronic device 100 and another mobile terminal, communications between the electronic device 100 and an external server. Further, the wireless communication unit 110 typically includes one or more modules which connect the electronic device 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the electronic device, the surrounding environment of the electronic device, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The electronic device 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the electronic device 100 and a user, as well as function as the user input unit 123 which provides an input interface between the electronic device 100 and the user.

The interface unit 160 serves as an interface with various types of external devices that can be coupled to the electronic device 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the electronic device 100 may perform assorted control functions associated with a connected external device, in response to the external device being connected to the interface unit 160.

The memory 170 is typically implemented to store data to support various functions or features of the electronic device 100. For instance, the memory 170 may be configured to store application programs executed in the electronic device 100, data or instructions for operations of the electronic device 100, and the like. Some of these application programs may be downloaded from an external server via wireless communication. Other application programs may be installed within the electronic device 100 at time of manufacturing or shipping, which is typically the case for basic functions of the electronic device 100 (for example, receiving a call, placing a call, receiving a message, sending a message, and the like). It is common for application programs to be stored in the memory 170, installed in the electronic device 100, and executed by the controller 180 to perform an operation (or function) for the electronic device 100.

The controller 180 typically functions to control overall operation of the electronic device 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the electronic device 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the electronic device 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WibroWiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the electronic device 100 and a wireless communication system, communications between the electronic device 100 and another electronic device 100, or communications between the electronic device and a network where another electronic device 100 (or an external server) is located, via wireless personal area networks. One example of the wireless area networks is a wireless personal area networks.

In some embodiments, another mobile terminal (which may be configured similarly to electronic device 100) may be a wearable device, for example, a smart watch, a smart glass or a head mounted display (HMD), which is able to exchange data with the electronic device 100 (or otherwise cooperate with the electronic device 100). The short-range communication module 114 may sense or recognize the wearable device, and permit communication between the wearable device and the electronic device 100. In addition, when the sensed wearable device is a device which is authenticated to communicate with the electronic device 100, the controller 180, for example, may cause transmission of data processed in the electronic device 100 to the wearable device via the short-range communication module 114. Hence, a user of the wearable device may use the data processed in the electronic device 100 on the wearable device. For example, when a call is received in the electronic device 100, the user may answer the call using the wearable device. Also, when a message is received in the electronic device 100, the user can check the received message using the wearable device.

The location information module 115 is generally configured to detect, calculate, derive or otherwise identify a position of the electronic device. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the electronic device.

As one example, when the electronic device uses a GPS module, a position of the electronic device may be acquired using a signal sent from a GPS satellite. As another example, when the electronic device uses the Wi-Fi module, a position of the electronic device can be acquired based on information related to a wireless access point (AP) which transmits or receives a wireless signal to or from the Wi-Fi module.

The input unit 120 may be configured to permit various types of input to the electronic device 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the electronic device 100. As another example, the cameras 121 may be located in a stereoscopic arrangement to acquire left and right images for implementing a stereoscopic image.

The microphone 122 is generally implemented to permit audio input to the electronic device 100. The audio input can be processed in various manners according to a function being executed in the electronic device 100. If desired, the microphone 122 may include assorted noise removing algorithms to remove unwanted noise generated in the course of receiving the external audio.

The user input unit 123 is a component that permits input by a user. Such user input may enable the controller 180 to control operation of the electronic device 100. The user input unit 123 may include one or more of a mechanical input element (for example, a key, a button located on a front and/or rear surface or a side surface of the electronic device 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the electronic device at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the electronic device, surrounding environment information of the electronic device, user information, or the like. The controller 180 generally cooperates with the sending unit 140 to control operation of the electronic device 100 or execute data processing, a function or an operation associated with an application program installed in the electronic device based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field or, infrared rays, or the like without a mechanical contact. The proximity sensor 141 may be arranged at an inner region of the electronic device covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the electronic device 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the electronic device 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

The camera 121 may be implemented using any of an assortment of camera or image sensors. Typical sensors include a photo sensor and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the electronic device 100. For example, the display unit 151 may display execution screen information of an application program executing at the electronic device 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the electronic device 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the electronic device 100.

An optical output module 154 can output a signal for indicating an event generation using light of a light source. Examples of events generated in the electronic device 100 may include message reception, call signal reception, a missed call, an alarm, a schedule notice, an email reception, information reception through an application, and the like.

A signal output by the optical output module 154 may be implemented in such a manner that the electronic device emits monochromatic light or light with a plurality of colors. The signal output may be terminated as the electronic device senses that a user has checked the generated event, for example.

The interface unit 160 serves as an interface for external devices to be connected with the electronic device 100. For example, the interface unit 160 can receive data transmitted from an external device, receive power to transfer to elements and components within the electronic device 100, or transmit internal data of the electronic device 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the electronic device 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the electronic device 100 is connected with an external cradle, the interface unit 160 can serve as a passage to allow power from the cradle to be supplied to the electronic device 100 or may serve as a passage to allow various command signals input by the user from the cradle to be transferred to the electronic device there through. Various command signals or power input from the cradle may operate as signals for recognizing that the electronic device is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The electronic device 100 may also be operated in relation to a network storage device that performs the storage function of the memory 170 over a network, such as the Internet.

The controller 180 may typically control the general operations of the electronic device 100. For example, the controller 180 may set or release a lock state for restricting a user from inputting a control command with respect to applications when a status of the electronic device meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the electronic device 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the electronic device 100 is described with reference to a bar-type terminal body. However, the electronic device 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of electronic device (for example, bar-type, watch-type, glasses-type, and the like). However, such teachings with regard to a particular type of electronic device will generally apply to other types of electronic devices as well.

The electronic device 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the electronic device 100 may be configured such that one case forms the inner space. In this example, an electronic device 100 having a uni-body is formed in such a manner that synthetic resin or metal extends from a side surface to a rear surface.

If desired, the electronic device 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the electronic device. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the electronic device 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the electronic device 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the electronic device 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the electronic device 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the electronic device 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the electronic device 100, but other locations are possible. If desired, multiple microphones may be implemented, with such an arrangement permitting the receiving of stereo sounds.

The interface unit 160 may serve as a path allowing the electronic device 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the electronic device 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject. As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the electronic device 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the electronic device 100 can also be provided on the electronic device 100. As one example of an accessory, a cover or pouch for covering or accommodating at least one surface of the electronic device 100 may be provided. The cover or pouch may cooperate with the display unit 151 to extend the function of the electronic device 100. Another example of the accessory is a touch pen for assisting or extending a touch input to a touch screen.

Further preferred embodiments will be described in more detail with reference to additional drawing figures. It is understood by those skilled in the art that the present features can be embodied in several forms without departing from the characteristics thereof.

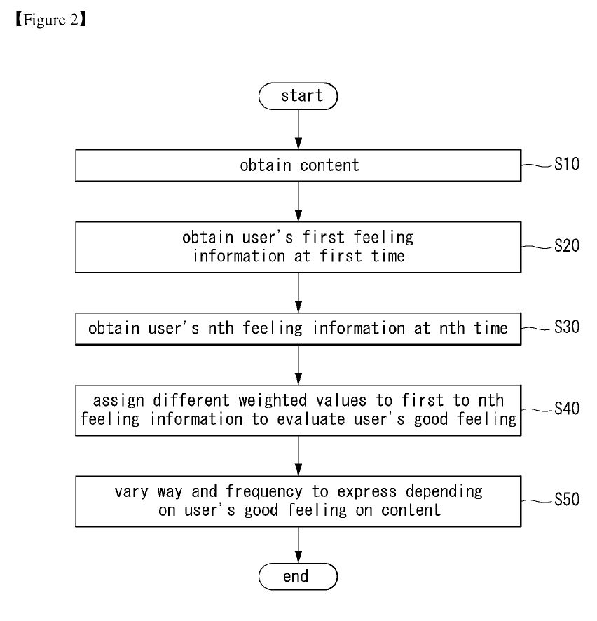

FIG. 2 is a flowchart illustrating an operation of an electronic device as shown in FIG. 1.

As shown in FIG. 2, according to an embodiment of the present invention, the controller 180 of the first electronic device 100 may perform the step (S10) of obtaining content.

The content may be obtained in various ways. For example, the content may be an image captured by the camera 121 of the electronic device 100 or a sound captured by the microphone 122 of the electronic device 100, or an image generated by a user's touch input through the display unit 151 of the electronic device 100, or an image or sound obtained through the wireless communication unit 110 from other device.

The content may be stored in the memory 170 of the electronic device 100. The content stored in the memory 170 is called as necessary and may be displayed through the display unit 151 and/or may be output through the audio output module 152. Hereinafter, the term “reproduce” may be used to include displaying and/or outputting. That is, the term “reproduce’ is defined to include displaying a still image, displaying a video, and outputting audio.

At a first time, obtaining a user's first feeling information (S20) may be performed. The feeling information may be data including a user's impression on content. For example, the feeling information may be the user's attitude on specific content. In other words, the feeling information may be the user's reaction at the time of reproducing the specific content.

The user's reaction to the specific content may be expressed in various ways. For example, the user's reaction may be expressed as a change in the user's bio signal at the time of reproduction of the specific content. That is, the user's reaction may be expressed as a change in his heart rate, body temperature, or eyeballs' movement.

The user's feeling information may be obtained at a specific time. For example, at the time the content is displayed on the display unit 151, a user's bio signal may be obtained as the feeling information.

The user's feeling information may be acquired through a sensor operating when content is reproduced. For example, upon reproduction of specific content that usually remains deactivated but needs to obtain feeling information, the sensor is operated to be able to obtain the feeling information. Such operation may be useful when there are a large amount of content. That is, the sensor may be selectively operated upon reproduction of content required to obtain feeling information among a plurality of content, thus allowing for better use of system resources such as battery.

At various specific times, the feeling information may be obtained. For example, the feeling information may be obtained at an initial time of reproduction of content or multiple times while the content is reproduced.

Obtaining the user's nth feeling information may be performed at an nth time (S30).

Content may be repeatedly reproduced. For example, pictures stored in the memory 170 may be viewed by users at different times.

The controller 180 may obtain feeling information if content is reproduced. For example, at the second time that the specific content is reproduced and at the third time that the specific content is reproduced.

The first to nth feeling information may be assigned with different weighted values, respectively, to evaluate a user's favorable information (S40).

The feeling information may be obtained repeatedly and/or cumulatively. The repeatedly and/or cumulatively obtained feeling information may be stored in the memory 170.

The controller 180 may evaluate the user's good feeling based on the stored feeling information. That is, the user's preference for the specific content may be yielded.

In evaluating the user's good feeling, a weighted value may be assigned. For example, a larger weighted value may be assigned to feeling information sensed most recently when yielding a good feeling. If a larger weighted value is given to the feeling information sensed most recently, the latest impression among a number of feeling information from past to now may have more influence on the yielded good feeling value. That is, the latest impression may be rendered to be reflected better.

The weighted values may differ from each other. For example, as described above, a larger weighted value may be oriented to recent feeling information rather than the past. Or, a predetermined gap may be placed when assigning weighted values. For example, a predetermined weighted value may be given to each time period, such as assigning weighted value A to the time period from now to one week ago, weighted value B to the time period from one week ago to two weeks ago, and weighted value C to the time period two weeks ago or earlier.

Depending on the user's good feeling on the content, varying the way or frequency to express (S50) may be carried out.

The electronic device 100 may store a plurality of content. The controller 180 may determine expressing the plurality of content stored, based on the user's good feeling on the content. For example, the way and frequency to express may be varied depending on the user's good feeling.

The way to express may be associated with the way to reproduce the content. Content with higher user good feeling may be positioned relatively ahead or as background image or in the first page. For example, in image gallery mode, thumbnail images may be arranged based on the user's good feeling.

The frequency to express may be associated with the time when the content is to be reproduced. Content with higher user good feeling may be reproduced relatively frequently or when the user has a higher stress index. For example, when the stress index is in excess of a first reference, content a with good feeling degree A is reproduced, and when the stress index exceeds a second reference, content b with good feeling degree B may be reproduced.

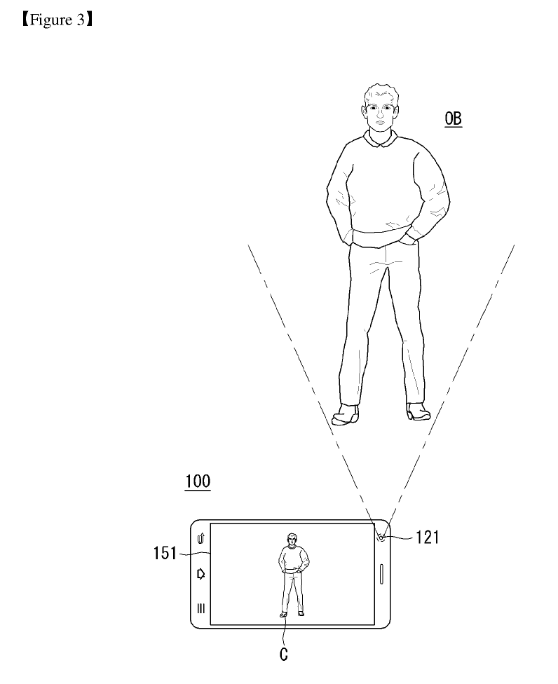

FIG. 3 is a view illustrating a method of obtaining content by an electronic device according to an embodiment of the present invention.

As shown in FIG. 3, the electronic device 100 according to an embodiment of the present invention may reproduce content C.

Content C may be generated through the electronic device 100. For example, an object OB may be taken picture of using the camera 121 of the electronic device 100. The captured image of the object OB may be content C generated by the electronic device 100. The generated content C may be stored in the memory 170.

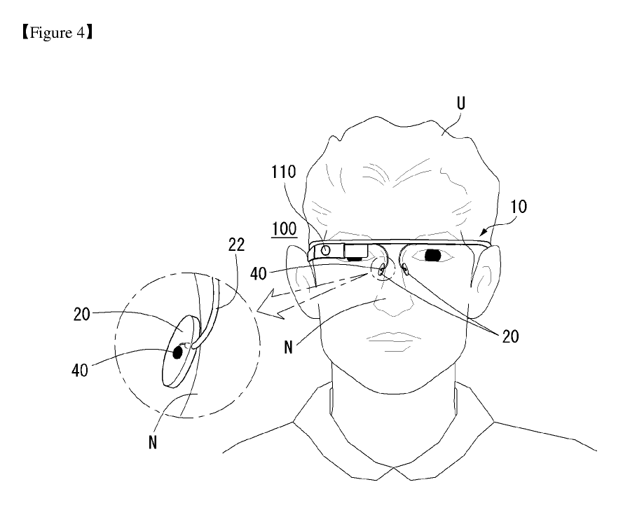

FIGS. 4 through 6 are views illustrating an electronic device sensor as shown in FIG. 1, according to an embodiment of the present invention.

As shown in FIG. 4, according to an embodiment of the present invention, the electronic device 100 may be a wearable device that may be put on a user's body. For example, the electronic device 100 may be an eyewear-type device that may be put on the user's face.

The wearable-type electronic device 100 may differ from the existing electronic devices in that the electronic device 100 may be put on the user (U)'s body. That is, although there seems to be similarity between the existing electronic device and the wearable-type electronic device 100 in light of portability, the wearable-type electronic device 100 according to the present invention is different from the existing electronic device in that the electronic device 100 remains in contact with at least a portion of the user (U)'s body. In view of such difference, the present invention may sense the user (U)'s bio signal substantially continuously or at a preset period.

Since the user (U)'s bio signal can be sensed continuously or at a preset period, a change in the bio signal that may occur without the user (U)'s notice may be known. In light of this aspect, the present invention differs from the prior art in which a notice is provided to a user to sense a bio signal so that the user (U) manipulates the electronic device to measure the bio signal. That is, since it contacts the user (U)'s body so that it can naturally sense a bio signal while the user remains unnoticed, no further operation is needed to sense the bio signal, thus allowing for more accurate detection of a bio signal.

The frame 40 may have a shape corresponding to a user's face when the electronic device 100 is of an eyewear type. For example, the frame 40 may be shaped as a semi-circle connecting the user's ears to each other. When the electronic device 100 is a type of eyewear that is put on the user's face, the frame 40 may be formed of lightweight metal or plastic. At least one point of the frame 40 may be in direct contact with the user (U)'s skin. For example, the frame 40 may contact the user's auricle to fix the body 10 to the user's face.

The frame 40 may be embedded with various electronic devices to operate the wearable device 100. For example, a camera 100 and its parts may be embedded in the frame 40.

A nose pad 20 may be formed to extend toward the user's nose (N) from the frame 40. The nose pad 20 contacts the user (U)'s nose (N) to support the electronic device 100. That is, the eyewear-type wearable device 100 may be in direct contact with the user (U)'s skin through at least the nose pad 20.

The sensor 40 may be positioned in the nose pad 20.

The nose pad 20 may be in direct contact with the user (U)'s nose (N). Accordingly, in case the sensor 40 is positioned in the nose pad 20, the user (U)'s bio signal may be more precisely obtained.

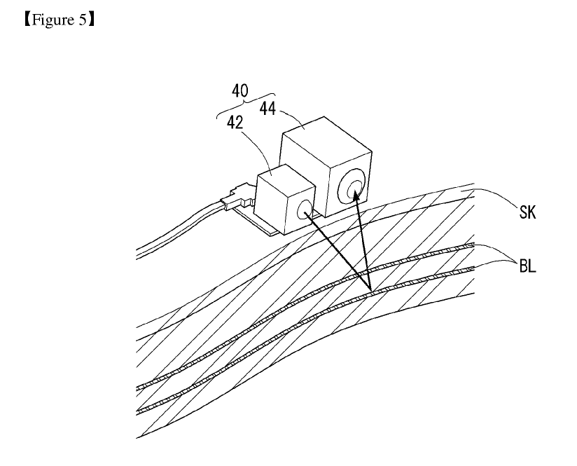

As shown in FIG. 5, the sensor 40 may observe the user's skin (SK) to obtain heartbeat information. The sensor 40 may include a light emitting unit 42 and a light receiving unit 44.

The light emitting unit 42 may radiate light to the user's skin (SK). The light emitting unit 42 may operate at the time heartbeat information is required, in response to a control signal from the controller. The light emitted from the light emitting unit 42 may be incident to a blood vessel (BL) under the user's skin (SK).

The light receiving unit 44 may sense the light reflected by the blood vessel (BL). The blood vessel (BL) may be a path through which the user's blood flows. The blood flowing through the blood vessel (BL) may go through a periodic change in its speed and/or amount depending on the heartbeat. Accordingly, when the reflected light is sensed, the user's heartbeat information. The light receiving unit 44 to sense the reflected light may be a camera.

The user's heartbeat information obtained through the light receiving unit 44 may be used as a piece of feeling information. For example, comparison between the user's normal heartbeat and his heartbeat obtained when specific content is reproduced allows for estimation of the user's impression for the content.

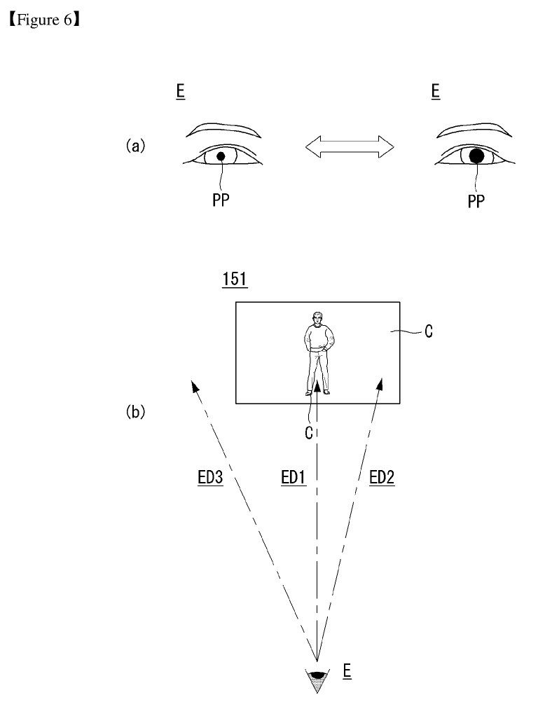

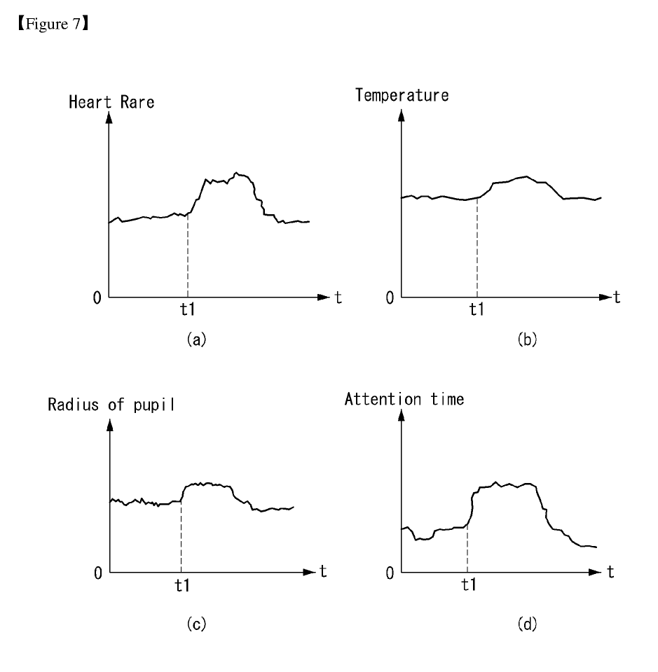

As shown in FIG. 6, feeling information may be obtained by observing the user's eye (E). For example, the electronic device 100 may have a camera that may observe the user's eye (E), and the camera that may observe the user's eye may function as a sensor for obtaining feeling information according to the present invention.

As shown in FIG. 6(a), a change in size of the pupil (PP) may be known by image capturing the user's eye (E). The size of the pupil (PP) may be changed between when an object of interest is viewed and when an object of no interest is viewed. For example, when an object of interest is viewed, the pupil (PP)'s diameter may be increased. In this point of view, a change in size of the pupil (PP) may be used as the user's feeling information for specific content.

As shown in FIG. 6(b), the display unit 151 may display specific content (C).

The user may observe the displayed specific content (C). There may be various user views as to the displayed content (C). For example, there may be a first view (ED1) oriented precisely toward the content (C), a second view (ED2) distributed toward the content (C), and a third view (ED3) oriented toward a region other than the region where the content (C) is positioned. The user's view may be sensed by a camera observing the user's eye (E).

The first to third views (ED1 to ED3) may be considered as reflecting the user's degree of interest in the content (C). For example, the first view (ED1) may be considered to show the highest degree of interest, and the third view (ED3) may be considered to show the lowest degree of interest.

The controller 180 may use the time period during which the user's view stays on the content (C) as feeling information to evaluate the user's degree of interest. For example, if the first view (ED1) stays relatively long, it may be deemed that the degree of interest in the content (C) is high. In contrast, although the content (C) is being displayed, if the third view (ED3) stays long time, it may be deemed that the degree of interest in the content (C) is low.

FIG. 7 is a view illustrating information sensed through a sensor in an electronic device as shown in FIG. 1, according to an embodiment of the present invention.

As shown in FIG. 7, according to an embodiment of the present invention, the electronic device 100 may use feeling information obtained through various sensors.

The controller 180 may use, as feeling information, heart rate data, body temperature data, pupil radius data, and view concentration data. The controller 180 may use a plurality of data in order to determine a user's impression for a specific content (C). That is, the controller 180 may combine first feeling information obtained through a first sensor with second feeling information obtained through a second sensor. For example, if it is known from the sensed heart rate data that there is a variation in the heartbeat at time t1, the body temperature data, pupil radius data, and/or view concentration data may also be considered to determine if it is meaningful data reflecting an impression for the content displayed at the time.

The controller 180 may evaluate good feeling based on the obtained feeling information. For example, a change in the heart rate may mean a variation in the good feeling about content being reproduced. The controller 180 may convert the good feeling into a numerical value based on the width and/or strength of the variation in the heart rate.

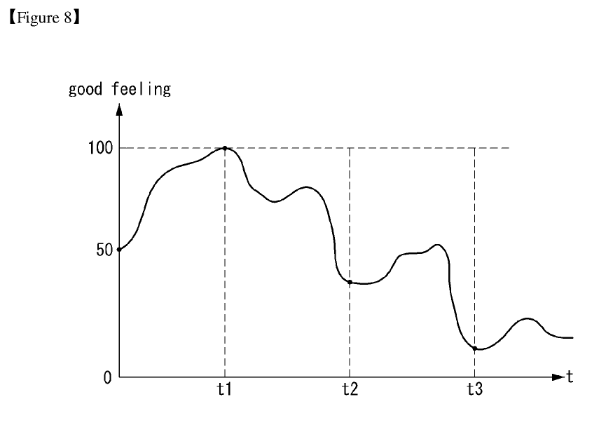

FIGS. 8 to 11 are views illustrating good feeling based on information obtained through an electronic device as shown in FIG. 1.

As shown in the figures, according to an embodiment of the present invention, the controller 180 of the electronic device 100 may change the degree of expressing content depending on changes over time in good feeling about specific content.

As shown in FIG. 8, good feeling for specific content may vary. For example, the good feeling was high at time t1, but as time goes by, the good feeling repeatedly goes up and down, so that at time t3, the good feeling may be rendered lower than the good feeling at time t1.

The controller 180 may differently express the content depending on the change in the good feeling for the specific content. For example, while at time t1 when the good feeling is high, the content is displayed so that the user may easily recognize the content, the degree of display may be decreased at time t3 when the good feeling is low.

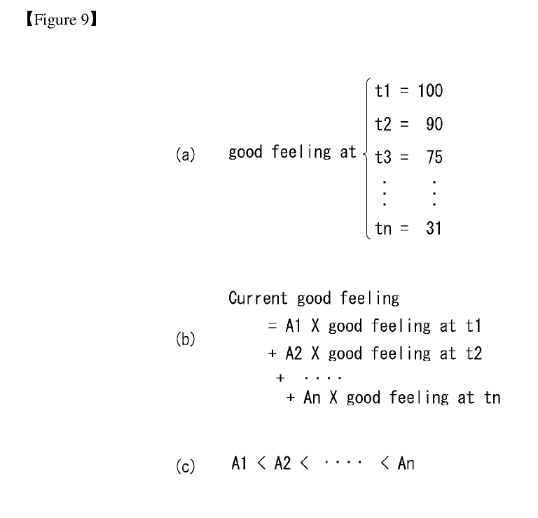

As shown in FIG. 9(a), the good feeling may vary depending on times. For example, at time t1 when a picture is captured, the degree of good feeling for the object or captured content may be 100, but at the present time, tn, the degree of good feeling may be turned down to 31.

As shown in FIG. 9(b) an (c), the controller 180 may compute the current good feeling. In computing the good feeling, weighted values (A1 through An) may be given. Among the weighted values (A1 to An), a weighted value for more recent time may be larger than a weighted value for the past time. That is, the weighted value may reflect good feelings from past to now, with a larger weighted value assigned to the current good feeling.

Upon computation the current good feeling, only good feelings from now back to a specific past time may be taken into account. For example, rather than the time period from t1 when corresponding content starts to be produced to tn, current time, the time period from t10 to the current time, tn, may be used as base to compute the current good feeling. Further, the weighted values (A1 to An), rather than all being always different from each other, may be different from each other depending on periods.

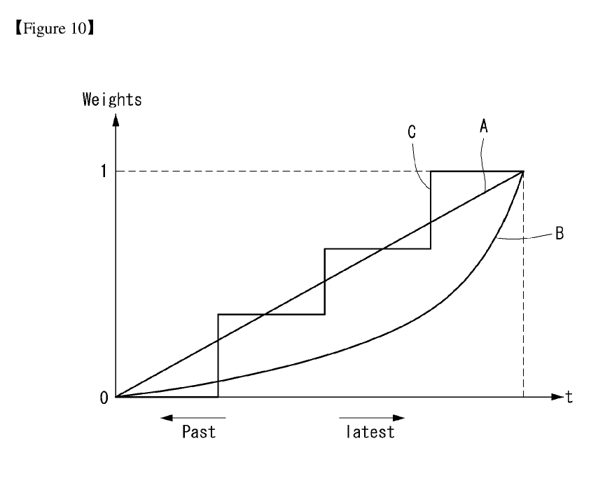

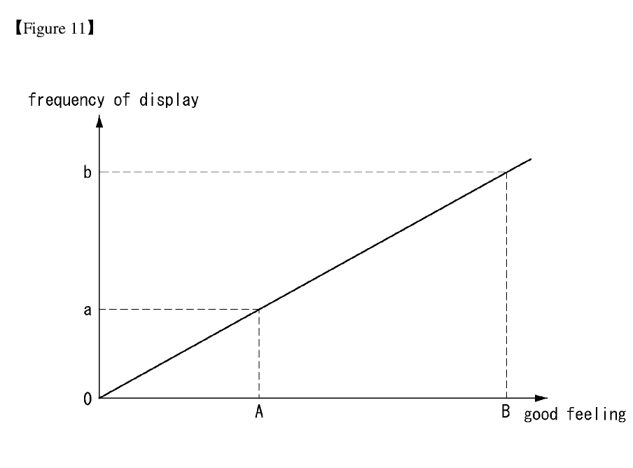

As shown in FIG. 10, a weighted value for the recent time may be larger than a weighted value for the past time. The weighted values may have a form A which shows a proportional increase from past to a recent time, form B which shows a sharp increase at the recent time, and form C which shows an increase per period.

As shown in FIG. 11, there may be a constant relation between the good feeling and the frequency to express. For example, when A<B and a<b, if the good feeling is A, the frequency to express may be a, while if the good feeling is B, the frequency to express may be b. In other words, if the good feeling is low, the content may be reproduced at a relatively low frequency.

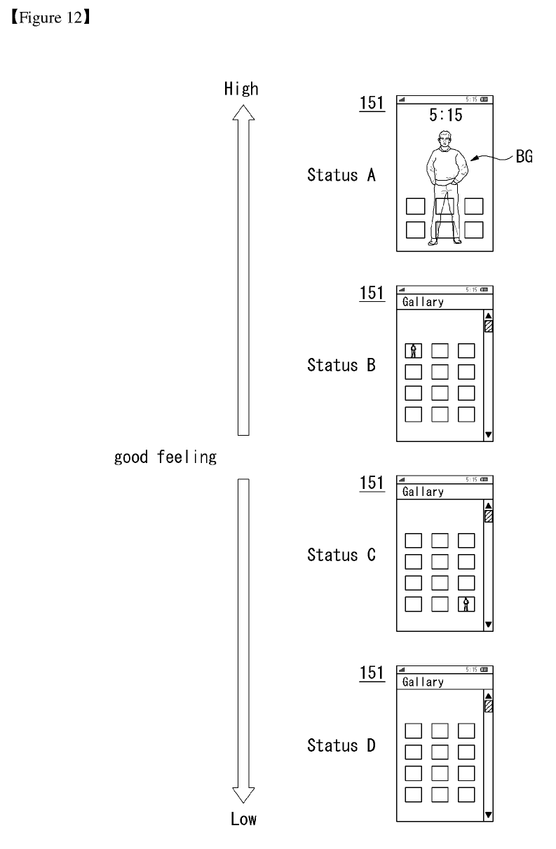

FIGS. 12 to 16 are views illustrating a method of using feeling information obtained through an electronic device as shown in FIG. 1.

As shown in the figures, according to an embodiment of the present invention, the electronic device 100 may vary ways to express content based on computed feeling information.

As shown in FIG. 12, in case the good feeling for content is state A, the controller 180 may express the content as background image (BG) of the display unit 151. That is, this is to allow the user to more frequently observe the content.

The controller 180 may obtain the user's feeling information for the content displayed as the background image (BG). For example, when the background image (BG) is displayed, the degree of viewing the user's background image (BG) may be sensed.

The controller 180 may express content in an image gallery according to changes in the user's feeling information. For example, in case the good feeling is state B, if the good feeling for the content being displayed as the background image (BG) is decreased, it may be rendered to be displayed only in the image gallery without being displayed on the background image (BG).

The controller 180, when the good feeling is state C, may vary the order of the content in the image gallery. For example, in case the good feeling is state B, the content is positioned in front of the image gallery, but in case the good feeling is state C, the content may be positioned behind the image gallery.

The controller 180, when the good feeling is state D, may bring the content further behind with respect to the image gallery. For example, the controller 180 may enable the content to be not shown on the first screen image of the image gallery. Further, in the above-described embodiment, the example where the good feeling is being reduced has been primarily described. However, an example where the good feeling is gradually on the rise may also be possible.

The controller 180 may rid the memory 170 of the content in case the user's good feeling is a predetermined value or lower and/or a low good feeling lasts a predetermined time. That is, the content which is not likely to be demanded by the user may be removed to secure memory 170 capacity. The controller 180 may notify the user of the content for which the user shows a predetermined good feeling degree or lower at a predetermined period, so that the user may determine whether to delete the content.

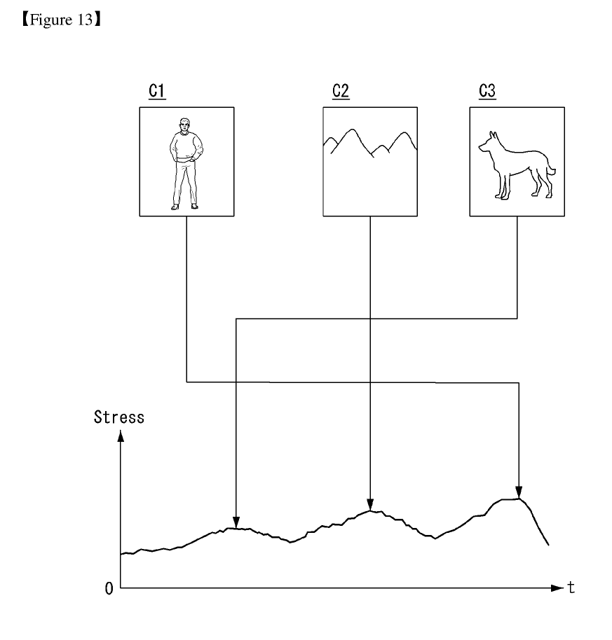

As shown in FIG. 13, the controller 180 may reproduce different types of content depending on the user's state. For example, the user's stress state may vary over time.

The controller 180, according to the user's stress state, may reproduce content corresponding to the user's stress state. For example, the user's good feeling may be higher for the second content (C2) than the first content (C1), and higher for the third content (C3) than the second content (C2). The controller 180, as the user's stress increases, may express content of higher user good feeling, allowing for effective control of the user's stress.

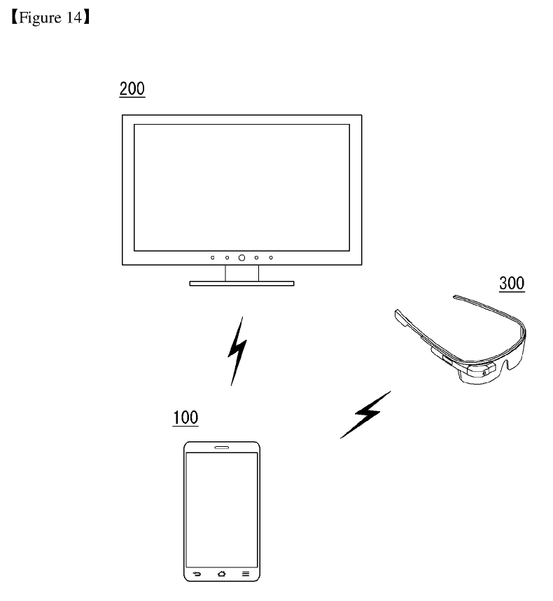

As shown in FIG. 14, the good feeling measured by the electronic device 100 may be shared with other devices 200 and 300. That is, rather than the good feeling being measured using only the electronic device 100, the good feeling may also be computed by other various devices 200 and 300 used by the user.

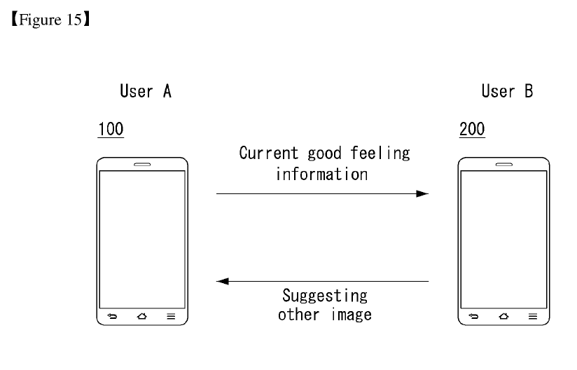

As shown in FIG. 15, the device 200 sharing the good feeling may offer content that may vary the good feeling. For example, user A who is a user of the electronic device 100 may retain content associated with user B of other electronic device 200. For example, a picture of user B may be in storage of the electronic device 100. The picture content of user B may be expressed to the electronic device 100 in response to user A's selection and/or a control signal from the controller 180 of the electronic device 100.

The electronic device 100 may send user A's good feeling data for user B's image to user B's electronic device 200.

The electronic device 200 may provide other image that may increase good feeling for user B based on user A's good feeling data for user B image. When receiving other image of user B, the controller 180 of the electronic device 100 may express it so that user A's good feeling for user B is varied.

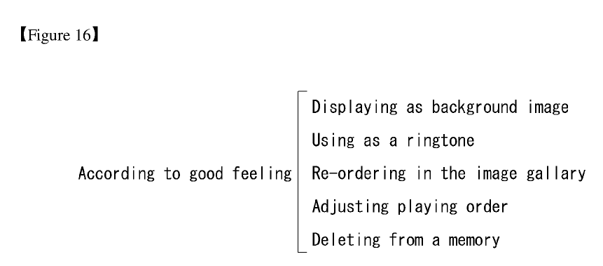

As shown in FIG. 16, content may be expressed in various ways depending on the good feeling. For example, when the good feeling degree is at a high level, an image may be used as a background image or sound may be used as ringtone. Depending on the degree of good feeling, the order in the image gallery may be changed or order of reproduction of sound files may be changed. In case the degree of good feeling is a predetermined value or lower, the content may be removed from the memory 170.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the electronic device.

The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

1. An electronic device comprising:
a sensor;
a memory storing content; and
a controller configured to:
acquire a plurality of feeling information on the content thorough the sensor which is operated when the content is reproduced;
evaluate a user's good feeling for the content based on the acquired plurality of feeling information;
calculate the user's good feeling using weighted values assigned to the plurality of feeling information,
wherein the controller is configured to apply a larger weighted value to latest feeling information among the plurality of feeling information.

2. The electronic device of claim 1, wherein the sensor includes a first sensor and a second sensor configured to obtain the user's good feeling, and wherein the controller is configured to evaluate the good feeling by a combination of first good feeling obtained through the first sensor and second good feeling obtained through the second sensor.

3. The electronic device of claim 1, wherein the good feeling includes first good feeling obtained at a first time of reproducing the first content and second good feeling obtained at a second time of reproducing the content, wherein the controller is configured to evaluate the good feeling by applying a first weighted value to the first time and a second weighted value to the second time when the first time is earlier than the second time, and wherein the first weighted value is smaller than the second weighted value.

4. The electronic device of claim 1, wherein the controller is configured to change a way to reproduce the content based on the good feeling.

5. The electronic device of claim 4, wherein the way to reproduce the content includes at least one of a position, frequency, or time of expressing the content.

6. The electronic device of claim 4, wherein the controller is configured to remove the content from the memory when the good feeling evaluated for the content is a predetermined degree or lower or when the good feeling is a predetermined degree or lower and lasts for a predetermined time.

7. The electronic device of claim 4, wherein the content is image content, and wherein the controller is configured to change an order of the image content in an image gallery depending on a degree of the good feeling for the image content.

8. The electronic device of claim 1, further comprising a wireless communication unit, and wherein the controller is configured to transmit the evaluated good feeling to a second electronic device through the wireless communication unit and to reproduce, instead of the content, second content obtained from the second device.

9. A method of controlling an electronic device, the method comprising:
obtaining content;
acquiring a plurality of feeling information on the content thorough the sensor which is operated when the content is reproduced;
evaluating a user's good feeling for the content based on the acquired plurality of feeling information;
calculating the user's good feeling using weighted values assigned to the plurality of feeling information; and
applying a larger weighted value to latest feeling information among the plurality of feeling information.

10. The method of claim 9, wherein acquiring the good feeling includes acquiring the good feeling through a plurality of sensors including a first sensor and a second sensor that may obtain the user's good feeling, and wherein evaluating the user's good feeling includes evaluating the good feeling by a combination of first good feeling obtained through the first sensor and second good feeling obtained through the second sensor.

11. The method of claim 9, the good feeling includes first good feeling obtained at a first time of reproducing the first content and second good feeling obtained at a second time of reproducing the content, wherein evaluating the good feeling includes evaluating the good feeling by applying a first weighted value to the first time and a second weighted value to the second time when the first time is earlier than the second time, and wherein the first weighted value is smaller than the second weighted value.

12. The method of claim 9, further comprising changing a way to reproduce the content based on the good feeling.

13. The method of claim 12, wherein the way to reproduce the content includes at least one of a position, frequency, or time of expressing the content.

14. The method of claim 9, wherein changing the way includes removing the content from the memory when the good feeling evaluated for the content is a predetermined degree or lower or when the good feeling is a predetermined degree or lower and lasts for a predetermined time.

15. The method of claim 9, further comprising:
transmitting the evaluated good feeling to a second electronic device; and
reproducing, instead of the content, second content obtained from the second device.
